(19) United States
(12) Patent Application Publication
(10) Pub. No.: US 2013/0138479 A1
(43) Pub. Date: May 30, 2013

(54) CLASSIFICATION OF NETWORK USERS BASED ON CORRESPONDING SOCIAL NETWORK BEHAVIOR

(71) Applicants: Saravanan Mohan, Chennai (IN); Suganthi Dewakar, Chennai (IN); Karishma Surana, Chennai (IN); Anand Varadarajan, Chennai (IN)

(72) Inventors: Saravanan Mohan, Chennai (IN); Suganthi Dewakar, Chennai (IN); Karishma Surana, Chennai (IN); Anand Varadarajan, Chennai (IN)

(73) Assignee: TELEFONAKTIEBOLAGET LM ERICSSON (publ), Stockholm (SE)

(21) Appl. No.: 13/699,796

(22) PCT Filed: Feb. 7, 2011
(86) PCT No.: PCT/SE2011/050133

§ 371 Date: Nov. 26, 2012

(30) Foreign Application Priority Data
May 24, 2010 (IN) 1208/DEL/2010

(51) Int. Cl. G06Q 30/02

(52) U.S. Cl. CPC G06Q 30/0204
USPC 705/7.33

(57) ABSTRACT

Exemplary embodiments described herein permit classification of a new mobile user in a communication network based on demographics associated with the new mobile user. The demographics may include all or any of age, income, occupation, frequency of mobile usage, time of mobile usage, and type of mobile usage associated with the mobile users. In an exemplary implementations described herein, the method of classification may include representing, for a sample set of mobile users, each mobile user by a node and mobile usage between two nodes by an edge connecting the two nodes. The method may further include forming one or more communities of nodes based on increasing modularity. Modularity is a measure of how closely two nodes or communities are connected. The method also includes identifying a plurality of subunits by splitting each of the one or more communities based on articulation point determination. Subsequently, the method includes determining one or more structural properties associated with each of the plurality of subunits. Next, the one or more structural properties are mapped to the demographics of the plurality of subunits. Finally, the method includes classifying the new mobile user based on the determined structural properties.

### TECHNICAL FIELD

Implementations described herein relate generally to social networks, and more particularly, to classifying network users based on their social network behavior.

### BACKGROUND

A social network can be defined as a social structure made up of individuals (or organizations) called “nodes”, which are tied (connected) by one or more specific types of interdependency, such as, friendship, kinship, common interest, financial exchange, dislike, or relationships of beliefs, knowledge, or prestige. An analysis of social network views social relationships in terms of network theory consisting of nodes and ties (also called edges, links, or connections). Nodes are the individual units within the networks, and ties are the relationships between the individual units. The resulting graph-based structures are often very complex. There can be many kinds of ties between the nodes. Research in a number of academic fields has shown that social networks operate on many levels, from families up to the level of nations, and play a critical role in determining the way problems are solved, organizations are run, and the degree to which individuals succeed in achieving their goals.

A well known example of a social network is a mobile communication network having millions of subscribers (hereinafter interchangeably referred to as users, consumers, customers) interconnected to each other through network infrastructures. Due to ever increasing demand and popularity of mobile communication, the consumer base has increased manifolds and a number of operators have emerged in the market in the last two decades. In order to maintain a competitive edge, service providers or operators invest a lot of resources to generate business intelligence reports that support marketing campaigns, advertisements, new service offerings, modification of existing service offerings, etc. Due to a large number of mobile users, it would be worthwhile, at least for some of the above-mentioned activities, such as, advertisements, to target a subset of mobile users instead of the complete consumer base. Such a targeted approach mandates profiling of the mobile users based on one or more considerations.

For instance, modern marketing needs include, understanding the behavior of the customers and trying to know who those customers are. It is desirable for the operators, in such scenarios, to know in advance, user details (here after referred to as demographic details) like, income, occupation, age group of users, etc. This allows the operators to tune and use their marketing resources efficiently and reap fortunes. In addition, knowing the customers, allows the operator to serve them in a better and efficient manner in terms of both cost and time.

One of the most important considerations for such profiling is demographics associated with the mobile users. Research has proven that demographics based profiling leads to better targeted approaches than other considerations. In general, demographics associated with mobile users are difficult to determine, more so when the mobile users have subscribed to pre-paid mobile services. One of the existing methods to determine demographics is to distribute a questionnaire to the mobile users to collect demographic details, such as, age group, occupation, frequency of calls, etc. Yet another known method includes collecting demographics details from databases (e.g. Call Data Records—CDR, Device data, Customer care data, Packet Data, etc.) maintained by the network operators and querying the database for demographic details to profile the mobile users.

Existing method needs considerable time in running a query (e.g. ORACLE query) and generating results for profiling of mobile users. In addition, existing methods involve graphical algorithms in network analysis that is complex and heavy on processing requirements.

In view of the above, there is a well-felt need for a fast and improved system/method for classifying network user in a social network, like mobile communication network, based on demographics of the network users.

### SUMMARY

It is an object of the present invention to obviate at least some of the above disadvantages and provide an improved system and method of classifying mobile users based on associated demographics.

It is a further object of the present invention to provide a fast and improved method for classification of mobile users in a communication network based on demographics associated with the mobile users.

It is yet another object of the present invention to provide a method for associating demographics of mobile users in a network with one or more structural properties of graphs representing closely connected mobile users.

It is another object of the present invention to provide systems for determining and presenting demographics of mobile users in a communication network.

It is an object of the present invention to provide systems and methods for targeted marketing of mobile communication services and allied services to mobile users based on demographics associated with the mobile users.

Exemplary embodiments described herein permit classification of a new mobile user in a communication network based on demographics associated with the new mobile user. The demographics may include all or any of age, income, occupation, frequency of mobile usage, time of mobile usage, and type of mobile usage associated with the mobile users. In an exemplary implementations described herein, the method of classification may include representing, for a sample set of mobile users, each mobile user by a node and mobile usage between two nodes by an edge connecting the two nodes. The method may further include forming one or more communities of nodes. In an implementation, the community formation is based on increasing modularity of nodes. Modularity is a measure of how closely two nodes or communities are connected. The method also includes identifying a plurality of demographic subunits by splitting each of the one or more communities. In an embodiment, the identification of subunits is based on articulation point determination. Subsequently, the method includes determining one or more structural properties associated with each of the plurality of subunits. Next, the method includes mapping the one or more structural properties to demographics of the plurality of subunits. Finally, the method includes classifying the new mobile user based on the determined structural properties.

Embodiments of systems are disclosed for determining and presenting demographics of mobile users in a communication network. In an implementation, the system includes a charging module configured to provide mobile usage data associated with the mobile users. The system may also include a customer information management (CIM) module configured to determine the demographics of the mobile users based on one or more structural properties. The one or more structural properties are associated with a plurality of graphs that represent closely connected mobile users and are determined based on the mobile usage data. The system may further include a visualization module configured to generate visual representation and statistical reports representing demographic details of mobile users.

Implementations of method are disclosed for associating demographics of mobile users in a network with one or more structural properties of graphs representing closely connected mobile users. In an embodiment, the method includes representing each mobile user by a node and mobile usage between two nodes by an edge and identifying one or more communities of nodes based on increasing modularity between the nodes. The method further includes splitting the one or more communities to obtain a plurality of densely connected subunits and labeling the plurality of subunits based on pre-determined mobile user behavior pattern. The method also includes determining one or more structural properties associated with the plurality of subunits and mapping the one or more structural properties with the labeling of the plurality of subunits. Subsequently, the method includes drawing inferences based on the mapping such that the one or more structural properties correspond to demographics associated with the mobile users.

Implementations of computing based systems are disclosed for determining demographics of mobile users in a mobile communication network. According to an exemplary embodiment, the computing based system includes a data collection module configured to collect mobile user data from one or more data sources. The system may also include a knowledge exploration and discovery module configured to selectively process the mobile user data using graphical means for determining the demographics associated with the mobile users based on one or more structural properties associated with the mobile users.

According to an aspect of the disclosed invention, the one or more structural properties may include degree centrality, closeness centrality, betweeness centrality, clustering coefficient, reciprocity, Z-score, and participation coefficient.

Additional features of the invention will be set forth in the description that follows, and in part will be obvious from the description, or may be learned by the practice of the invention. The features and advantages of the invention may be realized and obtained by means of the system and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail with the accompanying drawings in which:

FIG. 1 illustrates an exemplary system for determining and presenting demographics of mobile users in a communication network;

FIG. 2 illustrates an exemplary computing based system for determining demographics of mobile users in a mobile communication network;

FIG. 3 illustrates a flow chart for formation of a community of nodes representing mobile users according to an exemplary implementation;

FIG. 4 illustrates a flow chart for splitting of a community into subunits according to an exemplary implementation;

FIG. 5 illustrates an exemplary graph depicting distribution of count of calls, SMS, GPRS packets, and call duration over a whole day in an embodiment;

FIG. 6 illustrates an exemplary sequential diagram that depicts labeling of subunits based on demographics of mobile users in the subunits according to an embodiment;

FIG. 7 illustrates a flowchart illustrating determination of structural properties and mapping the calculated structural properties to subunits;

FIG. 8 illustrates an exemplary method for classification of mobile users in communication network based on demographics associated with mobile users in an embodiment; and

FIG. 9 illustrates an exemplary method for associating demographics of mobile users in network with one or more structural properties of graphs representing closely connected mobile users.

### DETAILED DESCRIPTION

The following detailed description of the invention refers to the accompanying drawings. The same reference numbers in different drawings may identify the same or similar elements. In addition, the following detailed description does not limit the invention.

Embodiments of systems and methods are disclosed that permit classification of mobile users in a social network based on demographics associated with the mobile users. Social network may be a mobile communication network, an online social network, telecommunication network, network of interne subscribers, and the like. Throughout this description, the term “demographics” refers to all or any of age, income, occupation, frequency of network usage, time of network usage, and type of usage associated with the network users. The usage data generated by different network users can be used as a source to know who these users are, by predictive ways. Instead of analyzing each user, analyzing the usage behavior of a network of highly connected group of users (a community) would yield better results. This is based on the idea that closely-knit users are similar kinds of people and exhibit similar usage behavior considering the large number of users subscribed to a network service provider. As described earlier, usage behavior and demographic details of a group of closely-knit or connected mobile users may be determined using conventional systems by using rule-based engines for running a query to classify mobile users. Such methods rely on one or more data sources or databases maintained by network operators or service providers.

The disclosed methods and systems not only provide for a simple and time efficient determination of user demographics but also provides for a correlation or association of one or more structural properties of graphs and user demographics. Although, the disclosed systems and methods are described in the context of mobile users in a mobile communication network, it should be appreciated that the principle, in general, can be applied to any social network analysis for determining user demographics or classification based thereon.

In an exemplary implementation described herein, the method of classification of new mobile user based on demographics may include representing, for a sample set of mobile users, each mobile user by a node and mobile usage between two nodes by an edge connecting the two nodes. The method further includes forming one or more communities of nodes. Various algorithms known in graph theory may be implemented for community formation. In one of the embodiments, the communities are formed based on increasing modularity. The method also includes identifying a plurality of subunits by splitting each of the one or more communities based on, graph algorithms, such as, articulation point algorithm. Subsequently, the method includes determining one or more structural properties associated with each of the plurality of subunits. Next, the one or more structural properties are mapped to demographics of the plurality of subunits. Finally, the method includes classifying the new mobile user based on the detetinined structural properties. The structural properties may include one or more of degree centrality, closeness centrality, betweeness centrality, clustering coefficient, reciprocity, Z-score, and participation coefficient amongst other well-known structural properties.

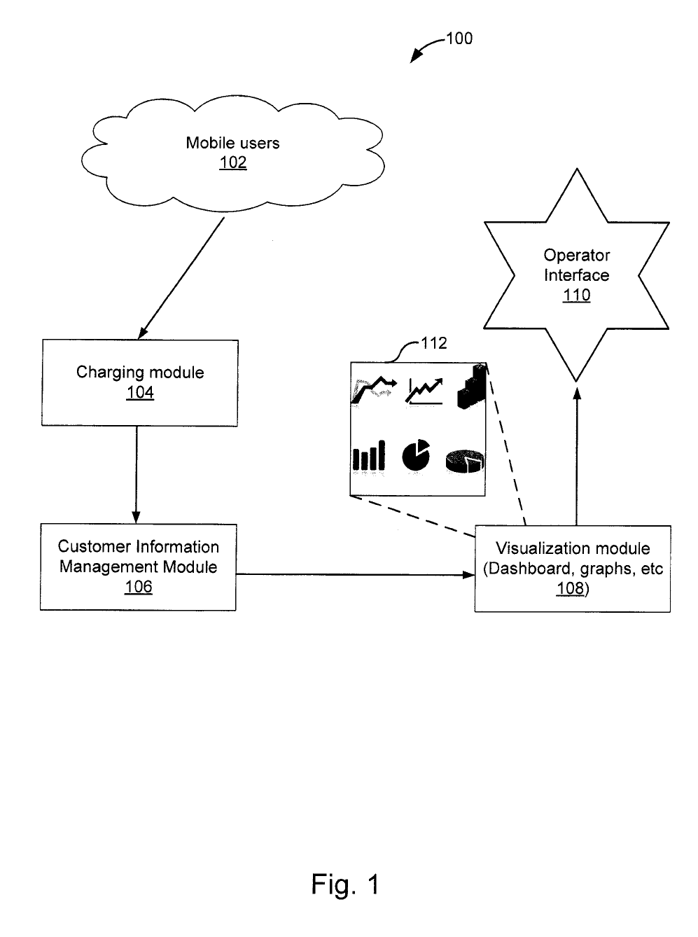

Referring to FIG. 1, an exemplary system 100 is illustrated, for determining and presenting demographics of mobile users in a communication network. As shown, the system 100 includes a plurality of mobile users 102 who form a customer base of a service provider. The mobile users 102 correspond to subscribers to mobile communication services. In a preferred embodiment, the mobile users 102 correspond to subscribers for “pre-paid” mobile communication services. It would be appreciated that the network operators or service providers do not have the demographic details of pre-paid subscribers. Current known methods for collecting such data include distributing a questionnaire to be completed by mobile users. Such a dependency on questionnaire is undesirable from an operator's point of view. The disclosed systems and methods still depends on predictive models for determining demographics but also correlates one or more structural properties to the user demographics. Such a correlation provides for an easier and quicker determination of user demographics based on which profiling of the user can be performed.

The system 100 includes a charging module 104 configured to provide mobile usage data associated with the mobile users 102. Mobile usage data includes the type of use, duration of use, location of mobile usage, number of calls made, and time (of day) of use, etc. Typically, every network operator or service provider employs one or more subsystems, such as, a charging system that maintains an account of mobile usage of mobile users for charging purposes.

The system 100 further includes a Customer Information Management (CIM) module 106 that embodies one or more basic modules for determining demographics of mobile users. In the exemplary embodiment, the demographics are determined based on one or more structural properties associated with a plurality of graphs that representing closely connected mobile users. The one or more structural properties are determined based on the mobile usage data from charging module 104. The structural properties of the network are a measurable quantity which is analyzed for the variation between the closely-knit groups of nodes and is a quick way to assign suitable labels for each distinct group. In a preferred implementation, structural properties can include any or all of degree centrality, closeness centrality, betweeness centrality, clustering coefficient, reciprocity, Z-score, and participation coefficient.

The system 100 further includes visualization module 108 configured to generate visual representation and statistical reports representing demographic details of mobile users 102. The visualization module 108 includes dashboards, graph generators, etc. that would enable a network operator or a service provider to create and view different graphical representations of the mobile user demographics and a classification thereof. The operator uses an operator interface 110 to prompt the visualization module 108 and to run the CIM module 106. The operator interface 110 enables a user to modify the system parameters of the CIM module 106 during various phases of determination of mobile user demographics as will be described hereinafter. Based on one or more commands or user selections at the operator interface 110, the visualization module 108 creates graphs, pie charts, etc, collectively shown as 112 in FIG. 1. It may be appreciated that the operator interface 110 may include a graphical user interface (GUI) to present such graphical representations to the user.

In general, network operators employ charging systems that embody solutions for collecting and maintaining large amounts of data. The disclosed system 100 may be modified to perform data mining in a manner suitable for the CIM module 106 to conduct customer analysis from a multi-media perspective. Customer Information Management and Analysis has been extensively used in various sectors like, banking, travel, retail, insurance, etc. The same concept can be extended to multi-media services using telecom & data communication environments that are being positioned as a customer-centric service, thereby posing an immediate need to understand “multi-media customers”.

One of the objectives of such systems is to target, retain, and deliver preferred services & features, based on one or more queries such as:
who is using the services and content,
what features and services are being used
when are these services and content being used
where are these used,
with whom these (services & content) are being used,
in which combination of services are being used, and
how much is customer spending in multi-media communicating environments. The answers to the above queries constitute the user data that can be obtained from the charging module 104. The CIM module 106 determines user (or customer) demographics based on such user data and profiles or classifies users (e.g. mobile users) based on determined demographics. Based on such profiling, an operator can launch targeted marketing campaigns with services and products that are custom-built for the mobile users.

The CIM module 106, therefore, provides a set of tools for operator's experts to reason Why and/or Why not a certain customer usage behavior or pattern is being observed in their network. In an aspect of the disclosed invention, a set of capabilities are made available to operator's knowledge expert to perform customer analysis & knowledge discovery in a time and cost efficient manner.

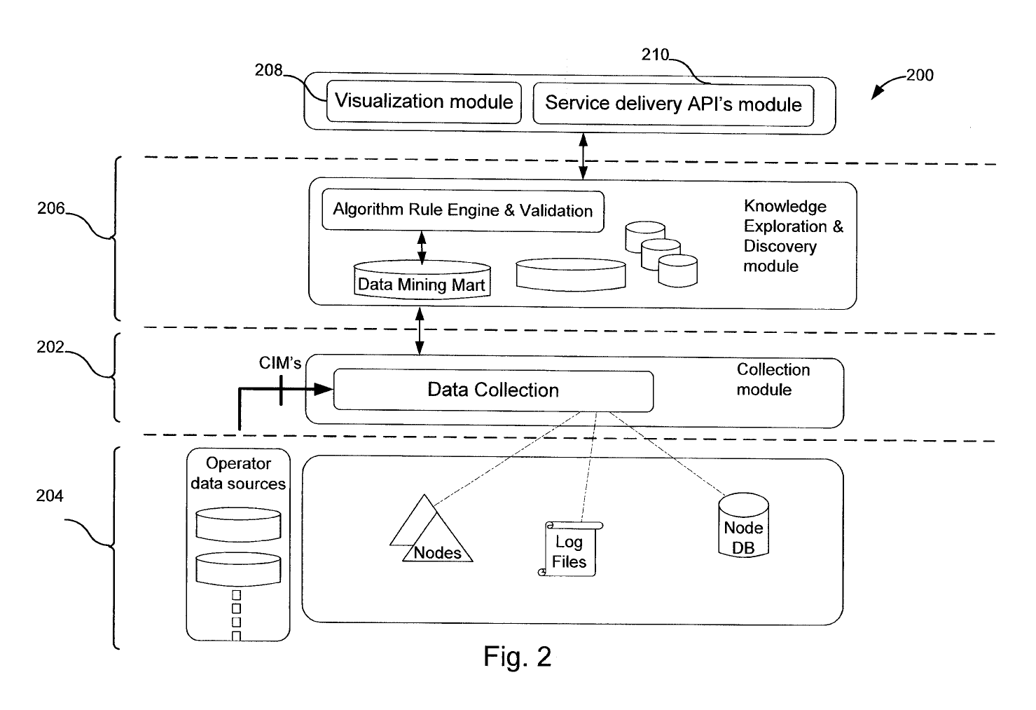

FIG. 1 has been described with specific references to a module-based approach. However, one or more modules as described above may be implemented in a multi-tier architecture for realization of a computing based system that classifies mobile users based on associated demographics. To this end, attention is drawn to FIG. 2 that illustrates an exemplary embodiment of a computing based system 200 for determining demographics of mobile users in a mobile communication network. Accordingly, the multi-tier architecture of CIM system 200 includes a data collection module 202 configured to collect mobile user data from one or more data sources 204. The data collection module 202 includes one or more data mining algorithms that access one or more data sources 204 to collate data in a specific format suitable for easy processing. The one or more data sources 204 may include operator's data sources, such as, Call Data Record (CDR), Charging Reporting System (CRS), Service Data Point (SDP), and Interactive Voice Response (IVR), Voucher data, Device data, Customer Care data, Packet Data, etc. The one or more data sources 204 may include node level databases, log files maintained by charging systems, knowledge data marts (KDMs), etc. The data collection module 204 may also include one or more routines (algorithms) that convert data files from one format to another for ease of processing and storage.

The system 200 further includes a knowledge exploration and discovery module 206 configured to selectively process the mobile user data using graphical means for generating one or more communities of mobile users. The knowledge exploration and discovery module 206 further splits each of the one or more communities into a plurality of subunits or graphs and determines the demographics associated with the mobile users based at least in part on one or more structural properties associated with the plurality of subunits.

The system 200 further includes a visualization module 208 configured to present statistical graphs, reports, graphical representations, etc. based on the determined demographics of mobile users. As discussed earlier, the visualization module 208 assists experts in modifying one or more rules running in the data collection module 202, knowledge exploration and discovery module 206 respectively.

The system 200 also includes a service delivery application program interface (API) module 210 configured to provide a subscription to the system 200. In one of the implementations, one or more components of the system 200 may be owned by a third party who can then provide subscription based access to the system 200. The subscribers can be the network operators or the service providers. Alternatively, the system 200 may be owned by the network operator and may be installed at the network operator's site. In such a scenario, the service delivery API 210 enables the operator to monitor the complete process, modify one or more parameters, generate visual presentations, etc.

It may be noted that FIG. 2 illustrates a multi-tier architecture of the system 200 in an embodiment. Accordingly, the system 200 may be implemented as three functional layers that may be executable in a distributed computing environment. The first layer corresponds to the data collection module 202 that supports collection of mobile user data from different data sources. The mobile user data includes type of mobile usage, provisioned mobile services, mobile devices details and customer demographic data, etc.

The first layer also involves extraction, transformation, and loading of mobile user data from the one or more data sources 204. This layer supports the flexibility to extract/process different data formats and prepare data as required by the target model or the knowledge exploration and discovery module 206. The first layer also layer performs data unification, normalization and consolidation.

The second layer in the multi-tier architecture corresponds to the knowledge exploration and discovery module 206. The second layer supports: data mining algorithms, possibility for selection of appropriate data mining algorithms, non-availability of certain data sets or partial availability of data sets that are supported with confidence building algorithms.

The third layer of the architecture corresponds to the visualization module 208 and the service delivery API module 210. The third layer supports presentation of knowledge to assist domain experts to interpret information, examine, and modify the mining rules, mining algorithms that have used in the second and first layers respectively. As discussed earlier, service delivery APIs are published to external systems and/or experts to subscribe to services and business activity monitoring capabilities provided by the system 200. One or more services that a user or an operator can subscribe to includes: initiating collection, processing, order data mining activities and obtaining data mart's results externally.

In operation, the system (100 or 200) operates in two phases to result in an analytical system embodying the principles of the disclosed invention. The first phase corresponds to training and testing of the system based on methods of determining demographics of mobile users and profiling based on such determination. A sample set of mobile users is considered for training and testing the system. In an embodiment, the mobile users correspond to pre-paid subscribers. In the first phase, the system identifies communities of mobile users and forms plurality of graphs or subunits from every community. The system then labels the graphs or subunits based on user behavior pattern, such as, usage pattern, spent pattern, and/or location pattern. In a successive progression, the system computes one or more structural properties associated with the graphs and correlate the structural properties of the graphs with the corresponding label. Based on the above correlation, a data structure may be generated that stores labels and corresponding values of structural properties. The data structure, in an embodiment, may correspond to a 2-dimensional array as shown in table 1 below:

TABLE 1

| Group | Participation | | Degree | Closeness | Betweenness | Clustering | | Class |
|---|---|---|---|---|---|---|---|---|
| ID | coefficient | Z score | centrality | centrality | centrality | coefficient | Reciprocity | label |
| G1 | 0.9269 | 2.32E−06 | 0.1042 | 0.3498 | 0.0596 | 0.336 | 0.506 | C |
| G2 | 0.8995 | 5.96E−07 | 0.2821 | 0.4589 | 0.1189 | 0.341 | 0.4828 | C |
| G3 | 0.0712 | 1.19E−06 | 0.3333 | 0.5256 | 0.1194 | 0.4133 | 0.5714 | H |
| G4 | 0.7037 | −3.43E−07 | 0.3611 | 0.527 | 0.1429 | 0.4333 | 0.7 | H |
| G5 | 0.9877 | 1.79E−07 | 0.3571 | 0.5179 | 0.1726 | 0.3917 | 0.6667 | H |
| G6 | 0.1346 | 5.36E−07 | 0.2444 | 0.4472 | 0.1667 | 0.0767 | 0.3077 | Y |
| G7 | 0.8687 | −5.36E−07 | 0.1978 | 0.3836 | 0.1474 | 0.15 | 0.5 | Y |
| G8 | 0.8892 | −4.77E−07 | 0.197 | 0.386 | 0.1727 | 0.175 | 0.375 | Y |
| G9 | 0.9752 | 1.27E−04 | 0.0051 | 0.1548 | 0.0077 | 0.1546 | 0.3858 | Y |
| G10 | 0.9886 | −2.38E−07 | 0.2545 | 0.4845 | 0.1293 | 0.3203 | 0.5263 | O |

Table 1 shows the structural properties of a community split into 10 groups (or graphs having Ids G1 to G10). The class label corresponds to classification of groups into various types of mobile users, such as, C—Corporate, H—Homebound, Y—Youth, and O—Others. The system draws inferences based on the generated data structure (e.g. table 1) and generates one or more rules to be implemented in one or more rule engines. By the end of the first phase, the system is said to have completed one cycle of training.

In an embodiment, the system can be tested for accuracy of the correlation and based on the test results may undergo multiple training cycles. System is tested by considering a sample set of graphs or subunits different from the ones considered during the training. The system generates the one or more structural properties for the sample set and based on the rules inferred from the data structure, the system classifies or labels the sample set of graphs. The sample set is also labeled separately based on the user behavior pattern as described earlier. The outcome of the two types of labeling is compared for delta errors. If there are errors beyond a pre-determined threshold, the system may be trained again to bring down the delta error. Once the delta error comes within permissible limits, the system is ready for a field implementation.

In the second phase, the trained and tested system simply runs the one or more rule engines to compute one or more structural properties for any graph or subsets corresponding to a new user (node) or subscriber. It may be appreciated that a “new user” refers to a mobile subscriber outside of the sample set of mobile users. Having trained the system with the sample set of mobile users, the system can now classify any new addition to the network or a new subscriber based on the inferences drawn during the training and testing of the system. The rule engine further enables the system to label or classify the new user (represented by a node) or subscriber based on the determined structural properties. Alternatively, the new user can be a user from the social network that has not been included in the sample set or in the testing set but was a subscriber in the network during phase 1. The new user can also refer to a subscriber who later joins the social network.

It is to be appreciated by those skilled in the art that the system may be subjected to the first phase periodically for different sets of mobile users or for different geographies for training and testing purposes. In general, the system variances have to be determined periodically to ensure accurate predictions based on structural properties.

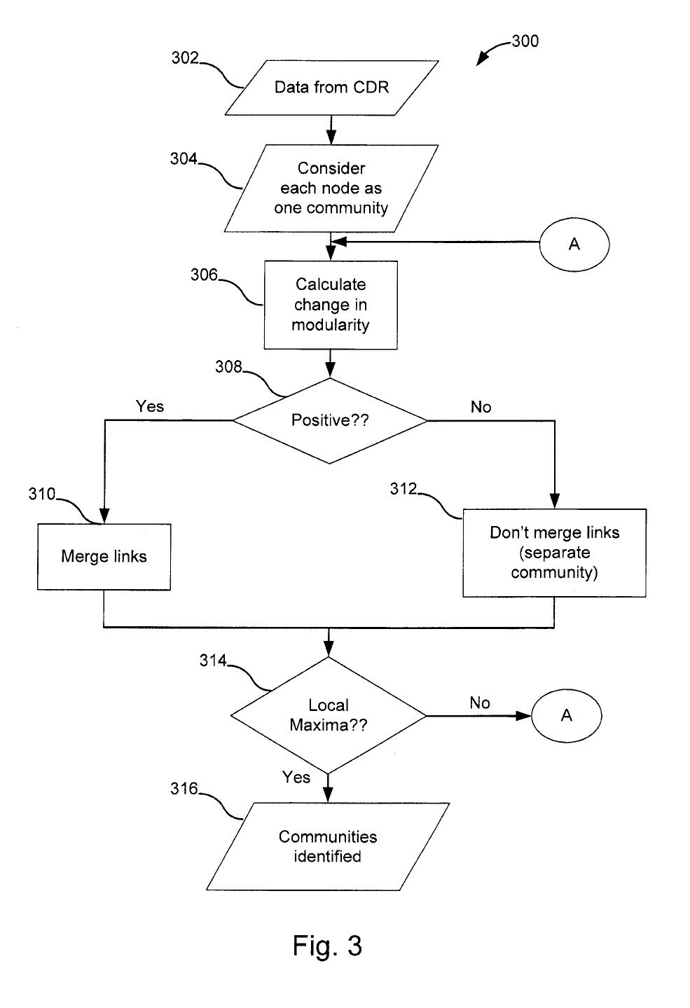

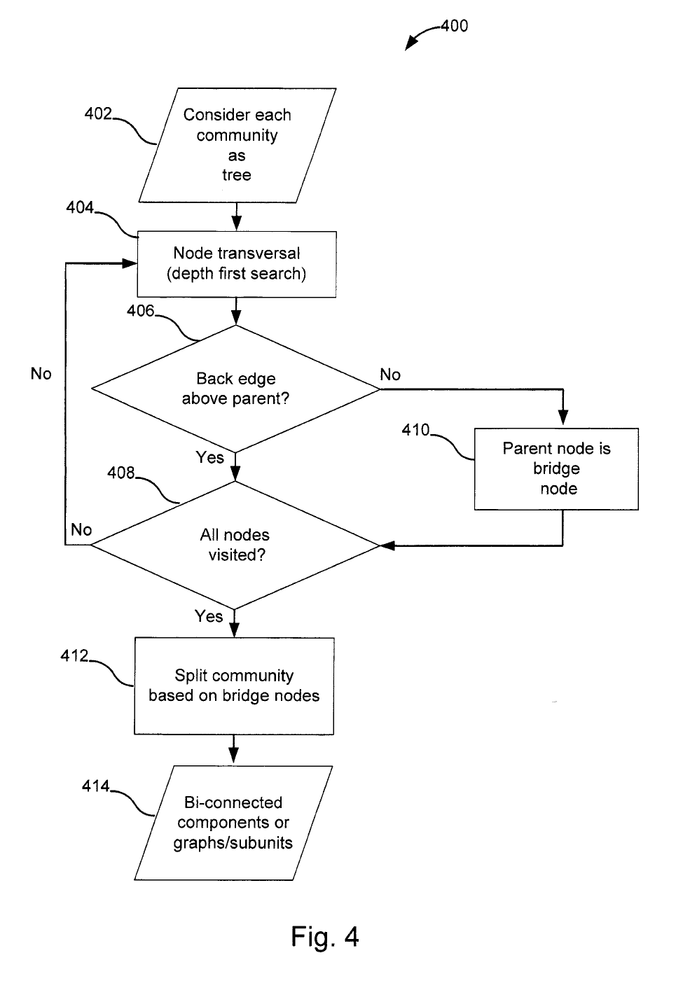

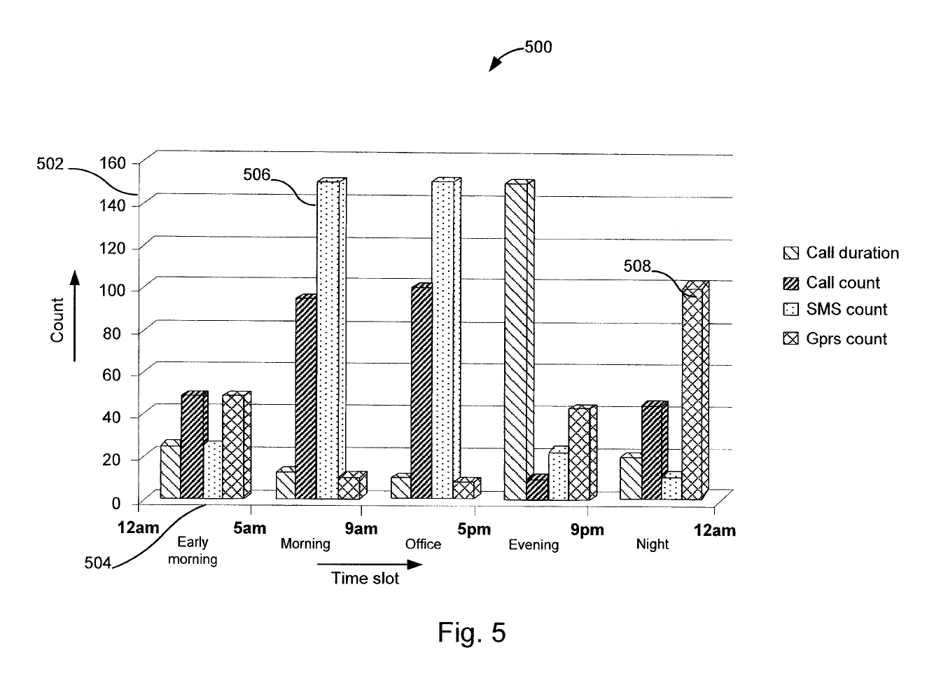

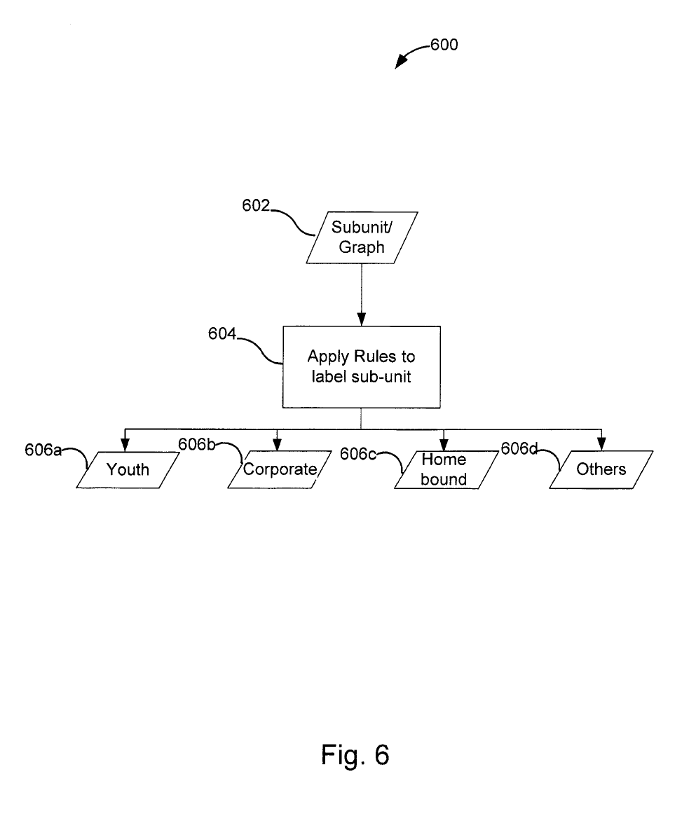

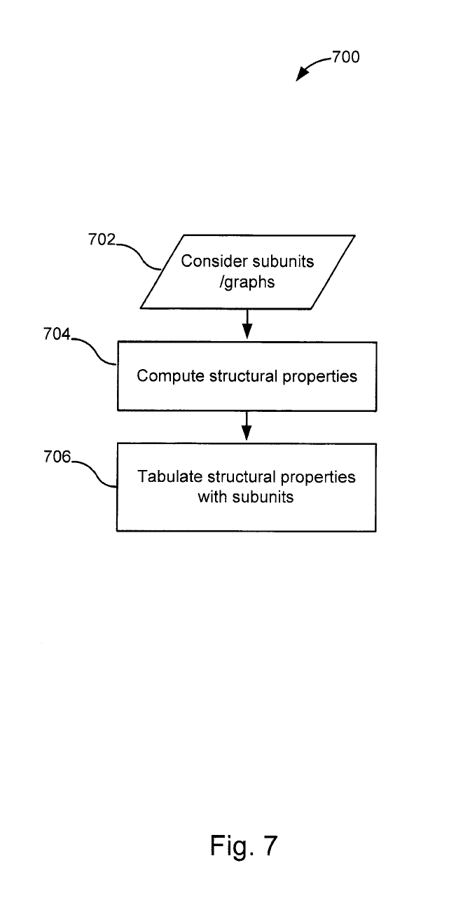

As described earlier, the system 100 or 200 operates in 2 phases. Each of these phases is described in detail with reference to FIG. 1, FIG. 2, FIG. 3, FIG. 4, FIG. 5, FIG. 6, and FIG. 7. It is to be appreciated that one or more components of system 100 correspond to one or more components of system 200. By way of example, the charging module 104 of system 100 can correspond to a combination of the data collection module 202 and one or more data sources 204. Similarly, the customer information management module 106 in system 100 can correspond to the knowledge exploration and discovery module 206 in system 200. Likewise, the visualization module 108 in system 100 can correspond to a combination of visualization module 208 and service delivery APLI's module 210 in system 200. Although the following description refers to the components of system 100, it is to be understood that similar description may be applicable to similar components in system 200 without limiting the scope of the ongoing disclosure.

### Phase 1:

Community Generation:

With reference to FIG. 1, the CIM module 106 receives mobile usage data from the charging module 104 and represents each mobile user by a node and mobile usage between two nodes by an edge. It is well known to represent social network users (such as mobile users or devices) as nodes and any connection there between as an edge between the nodes. Such a representation reduces a telecommunication network to a graph whereon one or more graphical algorithms can be implemented to analyze the characteristics of nodes or mobile users.

Next, the CIM module 106 identifies one or more communities of nodes based on increasing modularity between the nodes. As would be appreciated by those skilled in the art, study of a community or group of nodes would result in better results as compared to analysis of individual nodes. A community of nodes, if formed by increasing modularity, would result in closely-knit communities that have more frequent connections (interactions or instances of mobile usage) amongst the nodes in the community than the nodes in different communities. Community formation or identification is the process of gathering of vertices into groups such that there is a higher density of edges within groups than between the groups. It may be noted that any community generation algorithm may be implemented for the purposes of ongoing description.

Communities are formed by considering the gain in modularity when two or more communities, which are initially nodes, merge. In an exemplary embodiment, the CIM module 106 implements fast unfolding algorithm to identify communities based on increasing modularity. The community formation is divided into two phases. In the first phase, each node is designated as an individual community. Next, the modularity of this community is found with all its neighbors and the change in modularity value is evaluated. If there is a positive gain in modularity, the communities of nodes are merged into one. This procedure is applied to all nodes in the network. This first phase stops when a local maxima of the modularity is attained, i.e. when no individual move can improve the modularity. The algorithm's efficiency results from the fact that the gain in modularity ΔQ obtained by moving an isolated node i into a community (C) can be easily calculated. If

$${\sum }_{in}$$

represents the sum of the weights of the links inside C,

$${\sum }_{tot}$$

represents the sum of the weights of the links incident to nodes in C, kᵢ represents the sum of the weights of the links incident to node i, represents the sum of the weights of the links from i to nodes in C and m represents the sum of the weights of all the links in the network then, ΔQ can be calculated as follows,

$$Δ Q = [ \frac{{\sum }_{in} + 2 {k}_{i , in}}{2 m} - {( \frac{{\sum }_{tot} + {k}_{i}}{2 m} )}^{2} ] - [ \frac{{\sum }_{in}}{2 m} - {( \frac{{\sum }_{tot}}{2 m} )}^{2} - {( \frac{{k}_{i}}{2 m} )}^{2} ]$$

The second phase of the fast unfolding algorithm includes building a new network whose nodes now, are the communities found during the first phase. To do so, the weights of the links between the new nodes are given by the sum of the weight of the links between nodes in the corresponding two communities. Links between nodes of the same community lead to self-loops for this community in the new network. Once this second phase is completed, it is then possible to reapply the first phase of the algorithm to the resulting weighted network and to iterate. These two phases are iteratively performed unless stabilized value is reached.

Turning to FIG. 3, flow chart 300 for formation of a community of nodes representing mobile users is illustrated according to an exemplary implementation. The flowchart 300 corresponds to the first phase of the fast unfolding algorithm. Accordingly, at 302, the CIM module 106 receives data from charging module 104 (e.g. Call data Record—CDR). At 304, each node is considered as a community. At 306, for each community, the CIM module 106 evaluates the modularity with the neighboring communities (i.e. nodes in the first iteration) and a change in modularity is calculated. At 308, the CIM module determines whether the change in modularity is positive. As described earlier, the CIM module 106 identifies or generates communities based on increasing modularity. If the change in modularity is positive, the control flows to block 310 else the control flows to 312. At 310, the CIM module 106 merges the links between communities due to a positive change (increase) in modularity. On the other hand, at 312, the CIM module 106 does not merge the links between communities due to a negative change (decrease) in modularity. The control flows to block 314 from 310/312 where CIM module 106 determines whether a local maxima has been reached with regard to modularity. The CIM module 106 determines if there is any further increase in the modularity between communities. If the maxima has not been reached or the modularity still increases further then the flowchart control proceeds to A. If, on the other hand, the CIM module 106 determines that the local maxima has been reached and there is no further positive change in modularity, the CIM module 106 outputs the identified communities at 316.

Splitting of Communities:

Turning back to the first phase of operation of the system (100 or 200), the CIM module 106 now splits the one or more communities thus formed to obtain plurality of graphs or subunits. As discussed earlier, each community can be represented as a dense network of nodes (or mobile users), it would be worthwhile to split or divide each community to subunits or graphs that have similar characteristics with regard to node's behavior or usage pattern. Usage behavior of mobile users refers to a measurement of the usage of the various services provided by the telecom service providers. In order to predict demographics, of the mobile users, it is desirable to predict usage behavior of the mobile users.

In a preferred embodiment, the CIM module 106 implements a graph-splitting algorithm for splitting the community to plurality of graphs. Referring to FIG. 4, a flow chart for splitting of a community into subunits according to an exemplary implementation is illustrated. Applying graph theory approach for splitting the communities into graphs or subunits helps to further get closely connected components or nodes. It may be appreciated that there are various algorithms known for splitting a community to subunits or graphs and any of the algorithms may be applied for the purposes of the ongoing description.

In an exemplary embodiment, the CIM module 106 implements an articulation point algorithm to split the communities identified above into plurality of graphs or subunits. An articulation point refers to the demarcation point where the network is split into groups to eliminate the weakly linked groups. In a graph G=(V, E), v is an articulation point if:

removal of v in G results in a disconnected graph, and

there exist distinct nodes (or vertices) w and x such that v is in every path from w to x.

Again, there are many ways to determine an articulation point and any known method may be applied here for the purposes of the ongoing description. In a preferred embodiment, the CIM module 106 determines the articulation points in the communities by using Depth-First search (DFS). In a DFS tree of an undirected graph, a node ‘u’ is an articulation point if, for every child ‘v’ of ‘u’, there is no back edge from ‘v’ to a node higher in the DFS tree than ‘u’. That is, every node in the decedent tree of ‘u’ has no way to visit other nodes in the graph without passing through the node ‘u’, which is the articulation point. Since there is only one link which is present between the groups connected by the articulation, the groups are weekly linked, and this link can be eliminated to obtain densely connected subunits or graphs.

Referring to FIG. 4, a flow chart 400 for splitting of a community into subunits according to an exemplary implementation is illustrated. In a depth first search (DFS), for each node in DFS traversal, Dfsnum(v) and LOW(v) is calculated. Dfsnum(v) is indicative of whether node is visited or not, and LOW(v) is the lowest dfsnum of any node that is either in the DFS sub-tree rooted at v or connected to a node in that sub-tree by a back edge. Then, in DFS, if there are no more nodes to visit, the values of LOW are updated on return from each recursive call. The node ‘x’ indicates node(s) that is (are) connected to ‘v’. Consider a mapped graph, G=(V, E) where V corresponds to vertices and E corresponds to edges. This mapped graph represents the community of network users and is fed as an input to the CIM module 106. The output from CIM module 106 would be a cut vertex (or an articulation point), and bi-connected components or split graphs or subunits.

As shown in FIG. 4, at 402, each community is taken as a tree. At 404, the CIM module 106 carries out a node traversal (depth first search). At block 406, it is determined if the back edge is above the parent node, if the answer is yes, then at block 408, it is determined whether all the nodes have been visited or not. If at 406, it is determined that the back edge is not above the parent then, at 410, the parent edge is designated as the bridge node (or the articulation point). The control shifts to block 408. Now, if it is determined at 408 that all the nodes have been visited in the tree, then the process proceeds to block 412 where the community is split based on bridge nodes. As a result of the splitting at 412, bi-connected components are available as output at 414. If at 408, it is determined that all nodes have not been visited, the process proceeds to block 404. The whole process 400 is repeated for all the identified communities.

Labeling of Graphs/Subunits:

Subsequent to the splitting of the community into graphs or subunits, the CIM module 106 labels the plurality of graphs based on the mobile usage data provided by the charging module 104. Mobile usage data corresponds to a mobile usage behavior pattern that reflects characteristics of the group or graph under consideration. There are various parameters that could be taken into consideration for finding the behavior pattern of a particular group. In an embodiment, the behavior pattern includes one or more of usage pattern, spent pattern, and location pattern. The CIM module 106 labels the one or more graphs based on pre-determined mobile user behavior pattern.

In an embodiment, the usage pattern corresponds to frequency of usage, type of usage, and time of usage associated with the mobile users. Similarly, the spent pattern may correspond to high income, middle income, and low income associated with the mobile users. The location pattern may correspond to residential location, industrial location, and educational location associated with the mobile users. According to the usage pattern, three broad denominations may be, for example, “Youth”, “Corporate” and “Home Bound”. One or more rules can be fed into the rule engines running in the CIM module 106 that labels the groups or graphs based on the mobile user data. For instance, group of youth could be portrayed as one which has High frequency of SMS throughout the day, along with call frequency and usage high in the evening and having good level of reciprocity in messaging services as well as voice service. Similarly, group of corporate nodes could be found having comparatively less SMS with call frequency high during office hours only. By way of another example, group of home bound nodes may be characterized as having call duration more in the morning and evening, with least frequency of SMS.

For purposes of labelling based on time slots, the CIM module 106 divides a day into various time slots which can be defined by an operator expert via the operator interface 110. To this end, FIG. 5 illustrates an exemplary graph depicting distribution of count of calls, SMS, GPRS packets, and call duration over a whole day in an embodiment. As shown in the figure, the axis 502 depicts count corresponding to call duration, call count, SMS count, and GPRS count. Axis 504 depicts the time slots of a day during which the count 502 is monitored. In an embodiment, a day has been divided into 5 time slots: 12 am to 5 am referred to as “early morning, 5 am to 9 am referred to as “morning”, 9 am to 5 pm referred to as “office”, 5 pm to 9 pm referred to as “evening”, and 9 pm to 12 am referred to as “night”. It may be appreciated by those skilled in the art that there can be more than 5 time slots as defined by an operator expert and FIG. 5 illustrates a sample slot division only. As shown in FIG. 5, vertical bar 506 depicts a count of SMS during the “morning” time slot 504 and vertical bar 508 depicts the GPRS count during the “night” time slot.

With such time slots and based on mobile user data, the CIM module 106 applies one or more rules to label the groups. Turning to FIG. 6, an exemplary flowchart 600 is illustrated for labeling of one or more graphs based on mobile user data. Accordingly, at 602 each group (or graph) is considered for labeling and fed to rule engines embodied in the CIM module 106. At 604, the CIM module 106 applies the rules to the group and labels the groups as “youth” 606a, “corporate” 606b, “home bound” 606c, and “others” 606d. Table 2 shows a sample set of rules applied by the CIM module 106 to label the groups.

TABLE 2
Rules for identifying demographics and labeling

| | Voice | Messaging | Time | |
|---|---|---|---|---|
| Voice Usage | frequency | Service | of day | Label |
| >30 | >=1 | >10 | Night | Youth |
| >20 | >10 | >40 | Evening | Youth |
| >30 at night | <=6 | >30 during | — | Youth |
| | | office hours | | |
| >20 in evening | <=10 during | <=10 during | — | Home |
| | office hours | office hours | | Bound |
| <=30 during | <=6 during | <=5 | — | Home |
| office hours | office hours | | | Bound |
| >35 during | >5 in | <=1 at night | — | Home |
| office hours | evening | | | Bound |
| <=15 | >=20 during | >=10 in evening | — | Corporate |
| | office hours | | | |
| >=15 in evening | >=15 during | <=10 in morning | — | Corporate |
| | office hours | | | |
| <=10 in morning | >=15 during | >=15 in evening | — | Corporate |
| | office hours | | | |

For example, if the group makes a less frequent but long duration calls at night, with a high message service, the CIM module 106 labels the group as “Youth”. Table 2 corresponds to rules that are run in the rule engine at step 604 of FIG. 6.

In an alternative embodiment, the CIM module 106 uses the spend pattern to label the groups as “high income”, “low income” and “middle income” mobile users. One or more rules may be defined in the CIM module 106 to label groups based on the spending pattern of the mobile users in a group or graph. For instance, “high income” groups correspond to a spending of more than 1000 units of currency per month for making calls and GPRS and higher number of value added services in proportion to other groups. Similarly, “middle income” groups correspond to nodes spending approximately 500 units of currency per month and with lesser usage of GPRS and value added services as compared to “high income” groups. The “low income” groups correspond to nodes spending lesser amount than the other groups and using lesser services provided by the operator in comparison to other groups.

In yet another embodiment, the CIM module 106 can also label the groups based on location of the mobile users while they avail the mobile communication services. For instance, the CIM module 106 groups as ones that are based in “residential”, “industrial”, or “educational” areas. This is done by integrating the cell id of the mobile user with the geographical location. It would be appreciated that in mobile networks, cell id is used to represent a particular location of a tower (base station). The CIM module 106 labels the groups as one of the above by determining the location from where the nodes (or mobile users) make use of the services the most.

Computation of Structural Properties:

Returning to the first phase of operation, the CIM module 106 computes one or more structural properties associated with each of the subunits or graphs or groups. A structural property of a network can be considered as the metrics (measures) in social network analysis. In general, many structural properties are known in graph theory but one a select few have been used in the ongoing description. It may be appreciated that structural properties other than the ones described herein may be used without departing from the scope of the disclosed inventive concept. In an embodiment, the one or more structural properties include degree centrality, closeness centrality, betweeness centrality, clustering coefficient, reciprocity, Z-score, and participation coefficient.

For the purposes of ongoing description, clustering coefficient can be defined as a measure of likelihood that two associates of a node are associates. Accordingly, a higher clustering coefficient indicates a greater ‘cliquishness’. Degree can be defined as the count of ties to other nodes in the network. For a group of nodes, the degree would correspond to the average degree of the nodes within Closeness centrality can be defined as mean geodesic distance (i.e., the shortest path) between a node v and all other nodes reachable from v. Betweenness can be defined as a centrality measure of a node within a graph. Nodes that occur on many shortest paths between other nodes have higher betweenness. Reciprocity can be defined as a measure of how much the customer reciprocates with others. Reciprocity helps in understanding the nature of relationship between the nodes. Participation coefficient can be defined as a measure of how a node is positioned in its own network and with respect to other networks. Z-Score can be defined as a measure of how ‘well connected’ a node is to other nodes in the network.

Referring to FIG. 7, at 702, the CIM module 106 considers each of the plurality of graphs (already labeled) for computation of structural properties. At 704, the CIM module 106 computes one or more structural properties associated with the graphs, and at 706, the CIM module 106 tabulates the computed structural properties along with graph IDs. An example of such a tabulated data is shown in table 1 that stores values of various structural properties and the labeling of the graphs or groups. It is to be appreciated by those skilled in the art that known methods may be implemented to determine/compute the above mentioned structural properties without departing from the scope of the ongoing description.

Inferences from Structural Properties and Label of Graphs/Subunits:

The CIM module 106 determines the one or more structural properties associated with the plurality of graphs and map the one or more structural properties with the labeling of the plurality of graphs. The result of such a mapping is a data structure, such as table 1, as described above. In a successive progression, the CIM module 106 draws inferences based on the mapping (Table 1) such that the one or more structural properties correspond to demographics associated with the mobile users. The inferences may be implemented as one or more rules in rule engines embodied in the CIM module 106. It is to be noted here that inference rules generation is carried out during the first phase of operation.

In an implementation, sample data sets may be used to draw inferences. Based on the exemplary table 1, it may be inferred that corporate group has a high participation coefficient than the homebound, implying that the corporate groups interact to the outside world proportionately. Another inference may be that the homebound customers reciprocate in voice calls more than youth. Yet another inference may be that the corporate group has the highest z-score, ascertaining that nodes in the group have a higher in-out degree. The CIM module 106 creates a knowledge base using such inferences. Other observations may include higher degree centrality of home bound mobile users. It may also be inferred that closeness centrality of youth falls approximately between 0.1-0.2, which is lower than home bound users which in turn ranges between 0.4-0.5. Homebound mobile users are closely knit to each other in the group. Based on betweeness, it may be inferred that there are more influential users in youth than in corporate. The corporate group has the highest z-score, ascertaining that nodes in the group have a higher in-out degree.

The CIM module 106 may be trained by repeating the above-described steps of the first phase for multiple data sets. This results in better accuracy of mapping of labeling and structural properties.

Testing/Evaluation:

In the first phase of operation, the CIM module is tested for determining percentage of success and accordingly identifying the need for further training. In an embodiment, the testing may begin with a new data set other than the ones used during training. Next, the CIM module 106 performs the first two steps of phase 1 i.e. community identification and splitting. Subsequently, the CIM module 106 labels the graphs or subunits based on mobile user data as described during first phase. Concurrently, the CIM module 106 labels the graphs based on the one or more structural properties. Therefore, the CIM module 106 would have two labels for each graph using the two methods. The outputs are compared and a success rate can be determined for identifying need for further training of the CIM module 106. Further training would modify the values of the structural properties in table 1 such that the success rate (during evaluation) is above a predetermined threshold. In a preferred embodiment, the predetermined threshold lies in the range of 70-80%. Success rates may be further improved using multiple data sets and more structural properties than those described above.

Phase 2:

The second phase of operation of the CIM module 106 corresponds to actual field implementation where the system 100 classifies a new mobile user based on the structural properties determined in the first phase. The CIM module 106 determines one or more structural properties associated with the new user and classifies the new user (node) or subscriber based on the determined one or more structural properties (during phase 1). The mapping table 1 is used to classify the new user by mapping the one or more structural properties of the new user with the values in table 1. Thereafter, classification of the new user is performed based on inferences drawn during the training phase. Since, the labelling of the new user based on the structural properties makes use of data structures, such as, table 1; the CIM module 106 in a way correlates the one or more structural properties with demographics of mobile users.

As described earlier, the visualization module 108 generates one or more visual representations and statistical reports 112 that correspond to demographic details of mobile users (102) as determined above.

### Exemplary Methods

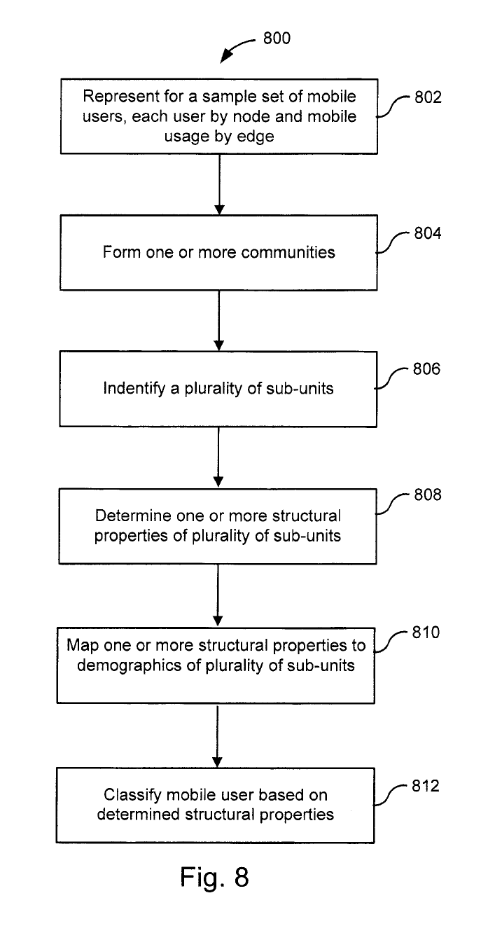

Referring to FIG. 8, an exemplary method 800 for classifying a new mobile user in a communication network based on demographics associated with the mobile user is illustrated. In a preferred embodiment, the new mobile user correspond to pre-paid mobile subscribers and the demographics associated with the mobile users correspond to all or any of age, income, occupation, frequency of mobile usage, time of mobile usage, and type of mobile usage associated with the new mobile user.

Accordingly, at block 802, for a sample set of mobile users, each mobile user is represented by a node and mobile usage between two nodes is represented by an edge connecting the two nodes. The CIM module 106 reduces the network of mobile users into a graph having nodes and edges. Analysis of social networks using graph theory yields useful results and hence millions of mobile users are represented as a dense network of nodes connected with edges.

At block 804, one or more communities of nodes are formed based on increasing modularity. Communities are formed by considering the gain in modularity when two or more communities, which are initially nodes, merge. In an exemplary embodiment, the CIM module 106 implements fast unfolding algorithm to identify communities based on increasing modularity.

At block 806, a plurality of subunits is identified by splitting each of the one or more communities based on articulation point determination. The CIM module 106 splits the one or more communities thus formed to obtain plurality of graphs or subunits. In an exemplary embodiment, the CIM module 106 implements an articulation point algorithm to split the communities identified above into plurality of graphs or subunits. An articulation point refers to the demarcation point where the network is split into groups to eliminate the weakly linked groups.

At block 808, one or more structural properties associated with each of the plurality of subunits are determined. The one or more structural properties correspond to demographics of the plurality of subunits. In an embodiment, the one or more structural properties correspond to degree centrality, closeness centrality, betweeness centrality, clustering coefficient, reciprocity, Z-score, and participation coefficient. It may be appreciated that the structural properties can be determined using various methods known in the art without departing from the scope of the disclosed systems and methods.

In an embodiment, the step of determining one or more structural properties includes labeling the plurality of subunits based on pre-determined mobile user behavior pattern. As described earlier, subsequent to the splitting of the community into graphs or subunits, the CIM module 106 labels the plurality of graphs based on the mobile usage data provided by the charging module 104. Such labeling is performed during the first phase of operation of the CIM module 106. Mobile usage data corresponds to a mobile usage behavior pattern that reflects characteristics of the group or graph under consideration. In an embodiment, the behaviour pattern includes one or more of usage pattern, spent pattern, and location pattern.

At block 810, the one or more structural properties are mapped with demographics of the plurality of subunits. During the first phase of operation, the CIM module 106 maps the labels with the one or more structural properties, thereby enabling the CIM module 106 to classify the subunits solely based on structural properties in the second phase.

At block 812, the new mobile user is classified based on the determined structural properties. The CIM module 106 classifies (or labels) new users (nodes) or subscribers based on the determined structural properties. The CIM module 106, during the first phase of operation creates a data structure (e.g. table 1) that embodies the mapping of pre-determined labels and computed structural properties. The CIM module 106 uses the data structure during the second phase of operation for classifying the new users based on structural properties computed for the new user. In contrast to the conventional methods of classifying mobile users based on demographics, the disclosed method takes less time and is less complex to implement. In the preferred embodiment, the run time for the query (for classification) is brought down to very few seconds which is a very small percent of the time taken by conventional systems and methods.

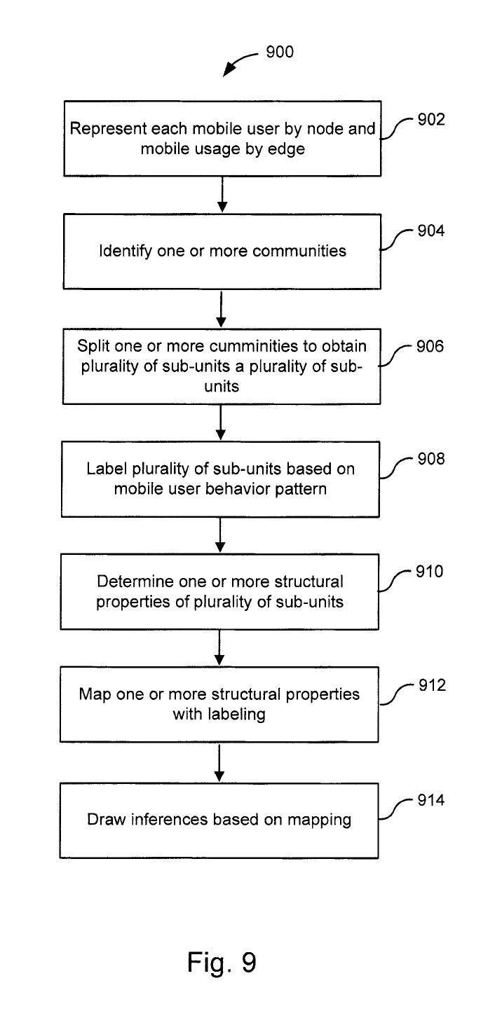

Referring to FIG. 9, an exemplary method 900 for associating demographics of mobile users in network with one or more structural properties of graphs representing closely connected mobile users, is illustrated. The method 900 corresponds to the first phase of operation of the system 100 during which the CIM module 106 is trained based on sample data sets of mobile users.

At block 902, each mobile user is represented by a node and mobile usage between two nodes by an edge. For ease of analysis and determining demographics of mobile users, the CIM module 106 during the first phase of operation, represents the network of mobile users as nodes connected by edges.

At block 904, one or more communities of nodes are identified based on increasing modularity between the nodes. The CIM module 106 generates or identifies communities of closely connected mobile users.

At block 906, the one or more communities are split to obtain a plurality of densely connected subunits. As described earlier, the CIM module 106 splits the identified communities into subunits.

At block labeling 908, the plurality of subunits is labeled based on pre-determined mobile user behavior pattern. In an embodiment, the mobile user behavior pattern corresponds to one or more of usage pattern, spent pattern and location pattern. The usage pattern may correspond to frequency of usage, type of usage and time of usage associated with the mobile users. The spent pattern may correspond to high income, middle income, and low income associated with the mobile users. The location pattern may include location of the mobile users from where the mobile communication services have been used the most. The location pattern, in an embodiment, may correspond to residential location, industrial location, and educational location associated with the mobile users.

At block 910, one or more structural properties associated with the plurality of subunits are determined. The CIM module 106 determines the structural properties for the sample set of mobile users for training during the first phase of operation.

At block 912, the one or more structural properties are mapped with the labeling of the plurality of subunits. As described earlier, the CIM module 106 maps the structural properties with the labeling of subunits determined at 908. In an embodiment, the CIM module 106 generates a data structure (e.g. table 1) that associates the determined one or more structural properties with the labeling of the sub-units.

At block 914, inferences are drawn based on the mapping such that the one or more structural properties correspond to demographics associated with the mobile users. As described earlier, the CIM module 106 generates inference rules based on table 1. Table 1 establishes a correlation between user demographics (labeling) and one or more structural properties associated with the subunits (or mobile users). Such correlation or association enables the CIM module 106 to determine demographics associated with mobile users and classify the mobile users based on such demographics solely based on structural properties during the second phase of operation.

Yet another embodiment of a method is disclosed for classifying a mobile user 102 in a communication network based on demographics associated with the mobile users. The method includes representing, for a sample set of mobile users, each mobile user by a node and mobile usage between two nodes by an edge connecting the two nodes at customer information management (CIM) module 106. The method further includes forming one or more communities of nodes based on increasing modularity at the CIM module 106. The method also includes identifying a plurality of subunits by splitting each of the one or more communities based on articulation point determination at the CIM module 106. The method includes determining one or more structural properties associated with each of the plurality of subunits at the CIM module 106. The one or more structural properties correspond to demographics of the plurality of subunits. The method further includes classifying the mobile user based on the determined structural properties at the CIM module 106

A still further embodiment of a method is disclosed for determining demographics of a new mobile user 102 in a mobile communication network. The method includes, at a customer information management module 106, determining one or more structural properties associated with a sample set of mobile users and mapping the one or more structural properties to demographics of the sample set of mobile users. The method further includes computing one or more structural properties associated with the new mobile user and determining, based on the computing and the mapping, the demographics associated with the new mobile user.

The above disclosed methods and systems are easy to incorporate into any Customer Information Management (CIM) domain based product. The disclosed systems and methods can be used for helping network operators or service providers in understanding customer behaviour in their network. In addition, the disclosed inventive concept can be modified to be used in any social network analysis model. The determination of structural properties can be used to identify group of subscribers for targeted marketing in a cost and time effective manner. The disclosed systems and methods provide for a way of correlation of one or more structural properties with user demographics. Such correlation makes the determination of user demographics faster and easier in comparison to existing methods. A faster determination of user demographics enables the operator to decide proper campaign or plan for the identified groups well in advance thereby giving an edge over competition.

The disclosed invention is advantageous over the existing methods and systems because the effectiveness of service up-take promotion is increased in the context of service providers. The calculation of the structural properties of a network is faster than the analysis of the usage behavior. The disclosed method does not require history of the customer's behavior as the conventional usage and spent analysis would require. The disclosed methods are efficient for dynamic knowledge of the demographics of a group of closely-knit nodes for immediate campaigning.

In addition to the above-mentioned advantages, the disclosed systems and methods enable an operator's experts to conduct reporting needed for management purposes and marketing, financial departments, monitor, and track service performance and customer uptake trends. In addition, the network operator can validate financial, marketing, management hypostasis with observed/processed data made available in data collection module 202. The operator can visualize customer clusters on the operator interface based on user behavior for targeted advertisements, launch of new services and/or promotions etc. The disclosed system also enables the operator expert to provide online product recommendation to other applications and/or 3^{rd} part program (3PP) service/content/advertisers providers. As discussed earlier, customer clusters data complemented with demographic data is mined for product associations using association rules algorithms. The disclosed system also provides automated support for identifying customers to receive a marketing campaign. The system disclosed herein provides online access to information to support dynamic portals to launch or render a service.

It will be appreciated that the number of components illustrated in FIG. 1 and FIG. 2 is exemplary. Other configurations with more, fewer, or a different arrangement of components may be implemented. Moreover, in some embodiments, one or more components in FIG. 1 and FIG. 2 may perform one or more of the tasks described as being performed by one or more other components in FIG. 1 and FIG. 2 respectively.

The foregoing description of implementations provides illustration and description, but is not intended to be exhaustive or to limit the invention to the precise form disclosed. Modifications and variations are possible in light of the above teachings, or may be acquired from practice of the invention. For example, while series of blocks have been described with regard to FIGS. 3, 4, 6, 7, 8, and 9, the order of the blocks may be modified in other implementations consistent with the principles of the invention. Further, non-dependent blocks may be performed in parallel. In some implementations, more blocks may be added to the exemplary processes of FIGS. 8 and 9.

Aspects of the invention may also be implemented in methods and/or computer program products. Accordingly, the invention may be embodied in hardware and/or in hardware/software (including firmware, resident software, microcode, etc.). Furthermore, the invention may take the form of a computer program product on a computer-usable or computer-readable storage medium having computer-usable or computer-readable program code embodied in the medium for use by or in connection with an instruction execution system. The actual software code or specialized control hardware used to implement embodiments described herein is not limiting of the invention. Thus, the operation and behavior of the aspects were described without reference to the specific software code—it being understood that one would be able to design software and control hardware to implement the aspects based on the description herein.

Furthermore, certain portions of the invention may be implemented as “logic” that performs one or more functions. This logic may include hardware, such as an application specific integrated circuit or field programmable gate array or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean, “based, at least in part, on” unless explicitly stated otherwise.

While certain present preferred embodiments of the invention and certain present preferred methods of practicing the same have been illustrated and described herein, it is to be distinctly understood that the invention is not limited thereto but may be otherwise variously embodied and practiced within the scope of the following claims.

1. A method for classifying a new mobile user in a communication network based on demographics associated with the new mobile user, the method comprising:
representing, for a sample set of mobile users, each mobile user in the sample set by a node and mobile usage between two nodes by an edge connecting the two nodes;
forming one or more communities of nodes;
identifying a plurality of demographic subunits by splitting each of the one or more communities;
determining one or more structural properties associated with each of the plurality of subunits;
mapping the one or more structural properties to demographics of the plurality of subunits; and
classifying the new mobile user based on the determined structural properties.

2. The method according to claim 1, wherein the forming one or more communities of nodes is based on increasing modularity using a Fast Unfolding Algorithm.

3. The method according to claim 1, wherein the identifying the plurality of subunits is based on articulation point determination.

4. The method according to claim 1, wherein the structural properties include any or all of degree centrality, closeness centrality, betweeness centrality, clustering coefficient, reciprocity, Z-score, and participation coefficient.

5. The method according to claim 1, wherein the mobile user corresponds to a pre-paid mobile subscriber.

6. The method according to claim 1, wherein the step of determining one or more structural properties associated with each of the plurality of subunits comprises labeling the plurality of subunits based on pre-determined mobile user behavior pattern.

7. The method according to claim 6, wherein the step of mapping includes mapping the one or more structural properties with the labeling of the plurality of subunits.

8. The method according to claim 1, wherein the demographics associated with the mobile users correspond to all or any of age, income, occupation, frequency of mobile usage, time of mobile usage, and type of mobile usage associated with the mobile users.

9. A system for determining and presenting demographics of mobile users in a communication network, the system comprising:
a charging module configured to provide mobile usage data associated with the mobile users;
a customer information management (CIM) module configured to determine the demographics of the mobile users based at least in part on one or more structural properties associated with a plurality of graphs representing closely connected mobile users, the one or more structural properties being determined based at least in part on the mobile usage data; and
a visualization module configured to generate visual representation and statistical reports representing demographic details of mobile users.

10. The system according to claim 9, wherein the customer information management module is further configurable to:
represent, for a sample set of mobile users, each mobile user by a node and mobile usage between two nodes by an edge; and
identify one or more communities of nodes based on increasing modularity between the nodes.

11. The system according to claim 10, wherein the customer information management module is further configurable to:
split the one or more communities to obtain the plurality of graphs; and
label the plurality of graphs based on the mobile usage data.

12. The system according to claim 11, wherein the customer information management module is further configurable to:
determine the one or more structural properties associated with the plurality of graphs;
map the one or more structural properties with the labeling of the plurality of graphs; and
draw inferences based on the mapping such that the one or more structural properties correspond to demographics associated with the mobile users.

13. The system according to claim 9, wherein the charging module comprises: charging reporting system (CRS), Call detail record (CDR), service data point (SDP), Interactive voice response (IVR), Voucher data, Device data, Customer Care data, Packet data, etc.

14. The system according to claim 9, wherein the demographics of the mobile users correspond to all or any of age, income, occupation, frequency of mobile usage, time of mobile usage, and type of mobile usage associated with the mobile users.

15. A method of associating demographics of mobile users in a network with one or more structural properties of graphs representing closely connected mobile users, the method comprising:
representing each mobile user by a node and mobile usage between two nodes by an edge;
identifying one or more communities of nodes based on increasing modularity between the nodes;
splitting the one or more communities to obtain a plurality of densely connected subunits;
labeling the plurality of subunits based on pre-determined mobile user behavior pattern;
determining one or more structural properties associated with the plurality of subunits;
mapping the one or more structural properties with the labeling of the plurality of subunits; and
drawing inferences based on the mapping such that the one or more structural properties correspond to demographics associated with the mobile users.

16. The method according to claim 15, wherein the mobile user behavior pattern comprises any or all of usage pattern, spent pattern and location pattern.

17. The method according to claim 16, wherein the usage pattern corresponds to frequency of usage, type of usage and time of usage associated with the mobile users.

18. The method according to claim 16, wherein the spent pattern corresponds to high income, middle income, and low income associated with the mobile users.

19. The method according to claim 16, wherein the location pattern corresponds to residential location, industrial location, and educational location associated with the mobile users.

20. A computing based system for determining demographics of mobile users in a mobile communication network, the system comprising:
a data collection module configured to collect mobile user data from one or more data sources; and
a knowledge exploration and discovery module configured to selectively process the mobile user data using graphical means for determining the demographics associated with the mobile users based at least in part on one or more structural properties associated with the mobile users.

21. The computing based system according to claim 20 further comprising:
a visualization module configured to:
present statistical graphs, reports, graphical representations based on the determined demographics of mobile users, and
assist experts in modifying one or more rules corresponding to data collection, knowledge exploration, and discovery respectively.

22. The computing based system according to claim 20 further comprising a service delivery application program interface (API) module configured to provide a subscription to the customer information management system.

23. The computing based system according to claim 20, wherein the one or more data sources comprises one or more of Call Data Record (CDR), Charging Reporting System (CRS), Service Data Point (SDP), Interactive Voice Response (IVR), Voucher data, Device data, Customer Care data, Packet data, etc.

24. A method for classifying a new mobile user in a communication network based on demographics associated with the new mobile users, the method comprising:
at a customer information management module;
representing, for a sample set of mobile users, each mobile user by a node and mobile usage between two nodes by an edge connecting the two nodes;
forming one or more communities of nodes based on increasing modularity;
identifying a plurality of subunits by splitting each of the one or more communities based on articulation point determination;
determining one or more structural properties associated with each of the plurality of subunits;
mapping the one or more structural properties to demographics of the plurality of subunits; and
classifying the new mobile user based on the determined structural properties.

25. A method for determining demographics of a new mobile user in a mobile communication network, the method comprising:
at a customer information management module:
determining one or more structural properties associated with a sample set of mobile users;
mapping the one or more structural properties to demographics of the sample set of mobile users;
computing one or more structural properties associated with the new mobile user; and
determining, based on the computing and the mapping, the demographics associated with the new mobile user.
